(19) United States
(12) Patent Application Publication
(10) Pub. No.: US 2026/0137092 A1
(43) Pub. Date: May 21, 2026

(54) Baking Stone

(71) Applicant: EPT Investments, LLC, Orland Park, IL (US)

(72) Inventors: Edward Patrick Thurmond, Chicago, IL (US); Gregory Harrison Worley, St. Louis, MO (US)

(21) Appl. No.: 19/395,870

(22) Filed: Nov. 20, 2025

Related U.S. Application Data
(60) Provisional application No. 63/723,536, filed on Nov. 21, 2024.

(51) Int. Cl. A21B 3/15

(52) U.S. Cl. CPC A21B 3/15

(57) ABSTRACT

A baking stone is disclosed herein. In one or more embodiments, the baking stone includes a stone body portion, the stone body portion including a first surface and a second surface, the second surface being oppositely disposed relative to the first surface, and the first surface having a textured surface geometry for enhancing control of heat transfer during a baking process, the textured surface geometry including pluralities of protrusions and recesses, the pluralities of protrusions and recesses configured to modify thermal dynamics between a baking surface and an item being baked. The baking stone enables cooking at increased temperatures, while minimizing a risk of burning a bottom of the item being baked, thereby improving an overall baking experience.

### CROSS-REFERENCE TO RELATED APPLICATIONS

This patent application claims priority to, and incorporates by reference in its entirety, U.S. Provisional Patent Application No. 63/723,536 , entitled “Baking Stone”, filed on Nov. 21, 2024.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL IN APPENDIX

A set of drawings depicting embodiments of baking stone images (FIGS. A-1 through A-21), and figure descriptions thereof, are attached as an appendix to this specification. The contents of these drawings and figure descriptions are hereby incorporated by reference in their entirety herein.

### BACKGROUND OF THE INVENTION

### 1. Field of the Invention

The invention generally relates to a baking stone. More particularly, the invention relates to a baking stone for enhancing control of heat transfer during a baking process.

### 2. Background

Conventional baking stones are known. Conventional baking stones are simple, flat, heat-retaining surfaces used in baking to create more evenly distributed heat in the oven. These stones are typically made from natural materials like ceramic, cordierite, or lava rock. The baking stones work by absorbing and retaining heat, helping to maintain a consistent temperature during baking, which leads to more even cooking and better results, especially for items like pizza, bread, pretzels, and pastries.

However, conventional baking stones do not allow for controlled variation in heat transfer across the baking surface, which can result in a less than desirable baking process.

Therefore, what is needed is a baking stone that strategically alters a contact surface area between the baking stone and the baked items, thereby facilitating differential heat diffusion in baked items.

### BRIEF SUMMARY OF EMBODIMENTS OF THE INVENTION

Accordingly, the present invention is directed to a baking stone that substantially obviates one or more problems resulting from the limitations and deficiencies of the related art.

In accordance with one or more embodiments of the present invention, there is provided a baking stone that includes a stone body portion, the stone body portion including a first surface and a second surface, the second surface being oppositely disposed relative to the first surface, and the first surface having a textured surface geometry for enhancing control of heat transfer during a baking process, the textured surface geometry including pluralities of protrusions and recesses, the pluralities of protrusions and recesses configured to modify thermal dynamics between a baking surface and an item being baked. In these one or more embodiments, the baking stone enables cooking at increased temperatures, while minimizing a risk of burning a bottom of the item being baked, thereby improving an overall baking experience.

In a further embodiment of the present invention, the first surface having the textured surface geometry is configured for high heat or specialized baking; and the second surface has a smooth surface geometry for low-temperature or standard baking such that the baking stone has a dual-surface design that provides flexibility in cooking methods to accommodate various baking needs.

In yet a further embodiment, the textured surface geometry of the first surface of the stone body portion comprises a series of randomly arranged protrusions and recesses that form high and low ribs so as to allow the item being baked to rest on the protrusions while minimizing direct contact with the recesses so as to alter a surface contact area of the item being baked, the baking stone configured to effectively regulate a heat transfer rate, thereby ensuring that a top of the item being baked cooks at a desired oven temperature, while the bottom of the item being baked cooks at a slower rate as compared to conventional baking devices.

In still a further embodiment, at least one of the recesses is configured to create a gap between the bottom of the item being baked and the first surface of the stone body portion so as to regulate the heat transfer rate of the baking stone.

In yet a further embodiment, the textured surface geometry of the first surface of the stone body portion comprises crater-like depressions that form high and low regions so as to allow the item being baked to rest on the high regions while minimizing direct contact with the low regions so as to alter a surface contact area of the item being baked, the baking stone configured to effectively regulate a heat transfer rate, thereby ensuring that a top of the item being baked cooks at a desired oven temperature, while the bottom of the item being baked cooks at a slower rate as compared to conventional baking devices.

In still a further embodiment, the textured surface geometry of the first surface of the stone body portion comprises a pebble-like texture that forms high and low regions so as to allow the item being baked to rest on the high regions while minimizing direct contact with the low regions so as to alter a surface contact area of the item being baked, the baking stone configured to effectively regulate a heat transfer rate, thereby ensuring that a top of the item being baked cooks at a desired oven temperature, while the bottom of the item being baked cooks at a slower rate as compared to conventional baking devices.

In yet a further embodiment, the pebble-like texture of the first surface of the stone body portion is further configured to impart a distinctive shape to the item being baked by allowing the bottom of the item being baked to conform to the pebble-like texture, thereby resulting in a unique appearance and enhanced authenticity in a final baked product.

In still a further embodiment, the textured surface geometry of the first surface of the stone body portion is further configured to provide a non-stick effect, thereby reducing a need for additional flours or oils during the baking process.

In yet a further embodiment, the second surface has an additional textured surface geometry configured for specialized baking such that the baking stone has a dual-surface design that provides flexibility in cooking methods to accommodate various baking needs.

In accordance with one or more other embodiments of the present invention, there is provided a baking stone that includes a stone body portion, the stone body portion including a first surface and a second surface, the second surface being oppositely disposed relative to the first surface, the first surface having a first textured surface geometry for enhancing control of heat transfer during a baking process, the second surface having a second textured surface geometry configured for specialized baking such that the baking stone has a dual-surface design that provides flexibility in cooking methods to accommodate various baking needs, at least one of the first textured surface geometry and the second textured surface geometry including pluralities of protrusions and recesses, the pluralities of protrusions and recesses configured to modify thermal dynamics between a baking surface and an item being baked. In these one or more embodiments, the baking stone enables cooking at increased temperatures, while minimizing a risk of burning a bottom of the item being baked, thereby improving an overall baking experience.

In a further embodiment of the present invention, the at least one of the first textured surface geometry and the second textured surface geometry of the stone body portion comprises a series of randomly arranged protrusions and recesses that form high and low ribs so as to allow the item being baked to rest on the protrusions while minimizing direct contact with the recesses so as to alter a surface contact area of the item being baked, the baking stone configured to effectively regulate a heat transfer rate, thereby ensuring that a top of the item being baked cooks at a desired oven temperature, while the bottom of the item being baked cooks at a slower rate as compared to conventional baking devices.

In yet a further embodiment, at least one of the recesses is configured to create a gap between the bottom of the item being baked and the first surface or the second surface of the stone body portion so as to regulate the heat transfer rate of the baking stone.

In still a further embodiment, at least one of the first textured surface geometry and the second textured surface geometry of the stone body portion is further configured to provide a non-stick effect, thereby reducing a need for additional flours or oils during the baking process.

It is to be understood that the foregoing general description and the following detailed description of the present invention are merely exemplary and explanatory in nature. As such, the foregoing general description and the following detailed description of the invention should not be construed to limit the scope of the appended claims in any sense.

### BRIEF DESCRIPTION OF THE SEVERAL VIEWS OF THE DRAWINGS

The invention will now be described, by way of example, with reference to the accompanying drawings, in which:

FIG. 1 is a side-top perspective view of a baking stone, according to a first illustrative embodiment of the invention;

FIG. 2 is a front elevational view of the baking stone shown in FIG. 1;

FIG. 3 is a rear elevational view of the baking stone shown in FIG. 1;

FIG. 4 is a first side elevational view of the baking stone shown in FIG. 1;

FIG. 5 is a second side elevational view of the baking stone shown in FIG. 1;

FIG. 6 is a top plan view of the baking stone shown in FIG. 1;

FIG. 7 is a bottom plan view of the baking stone shown in FIG. 1;

FIG. 8 is a side-top perspective view of a baking stone, according to a second illustrative embodiment of the invention;

FIG. 9 is a front elevational view of the baking stone shown in FIG. 8;

FIG. 10 is a rear elevational view of the baking stone shown in FIG. 8;

FIG. 11 is a first side elevational view of the baking stone shown in FIG. 8;

FIG. 12 is a second side elevational view of the baking stone shown in FIG. 8;

FIG. 13 is a top plan view of the baking stone shown in FIG. 8;

FIG. 14 is a bottom plan view of the baking stone shown in FIG. 8;

FIG. 15 is a side-top perspective view of a baking stone, according to a third illustrative embodiment of the invention;

FIG. 16 is a front elevational view of the baking stone shown in FIG. 15;

FIG. 17 is a rear elevational view of the baking stone shown in FIG. 15;

FIG. 18 is a first side elevational view of the baking stone shown in FIG. 15;

FIG. 19 is a second side elevational view of the baking stone shown in FIG. 15;

FIG. 20 is a top plan view of the baking stone shown in FIG. 15;

FIG. 21 is a bottom plan view of the baking stone shown in FIG. 15;

FIG. 22 is an enlarged partial cross-sectional view of a baking stone having a textured surface geometry similar to that of the first illustrative embodiment of FIG. 1;

FIG. 23 is an enlarged partial cross-sectional view of a baking stone having another textured surface geometry, according to a first alternative embodiment of the invention;

FIG. 24 is an enlarged partial cross-sectional view of a baking stone having yet another textured surface geometry, according to a second alternative embodiment of the invention;

FIG. 25 is an enlarged partial cross-sectional view of a baking stone having still another textured surface geometry, according to a third alternative embodiment of the invention;

FIG. 26 is an enlarged partial cross-sectional view of a baking stone having yet another textured surface geometry, according to a fourth alternative embodiment of the invention;

FIG. 27 is an enlarged partial cross-sectional view of a baking stone having still another textured surface geometry, according to a fifth alternative embodiment of the invention, which is similar to that of the second illustrative embodiment of FIG. 8;

FIG. 28 is an enlarged partial cross-sectional view of a baking stone having yet another textured surface geometry, according to a sixth alternative embodiment of the invention, which is similar to that of the third illustrative embodiment of FIG. 15;

FIG. 29 is a top plan view of a baking stone having a first alternative surface pattern, according to another illustrative embodiment of the invention;

FIG. 30 is a top plan view of a baking stone having a second alternative surface pattern, according to yet another illustrative embodiment of the invention;

FIG. 31 is a top plan view of a baking stone having a third alternative surface pattern, according to still another illustrative embodiment of the invention;

FIG. 32 is a top plan view of a baking stone having a fourth alternative surface pattern, according to yet another illustrative embodiment of the invention;

FIG. 33 is a top plan view of a baking stone having a fifth alternative surface pattern, according to still another illustrative embodiment of the invention;

FIG. 34 is a top plan view of a baking stone having a sixth alternative surface pattern, according to yet another illustrative embodiment of the invention;

FIG. 35 is a top plan view of a baking stone having a seventh alternative surface pattern, according to still another illustrative embodiment of the invention;

FIG. 36 is a top plan view of a baking stone having an eighth alternative surface pattern, according to yet another illustrative embodiment of the invention;

FIG. 37 is a top plan view of a baking stone having a ninth alternative surface pattern, according to still another illustrative embodiment of the invention;

FIG. 38 is a top plan view of a baking stone having a tenth alternative surface pattern, according to yet another illustrative embodiment of the invention; and

FIG. 39 is an enlarged partial cross-sectional view of a baking stone having a textured surface geometry on both sides, according to still another illustrative embodiment of the invention.

Throughout the figures, the same parts are always denoted using the same reference characters so that, as a general rule, they will only be described once.

### DETAILED DESCRIPTION OF EMBODIMENTS OF THE INVENTION

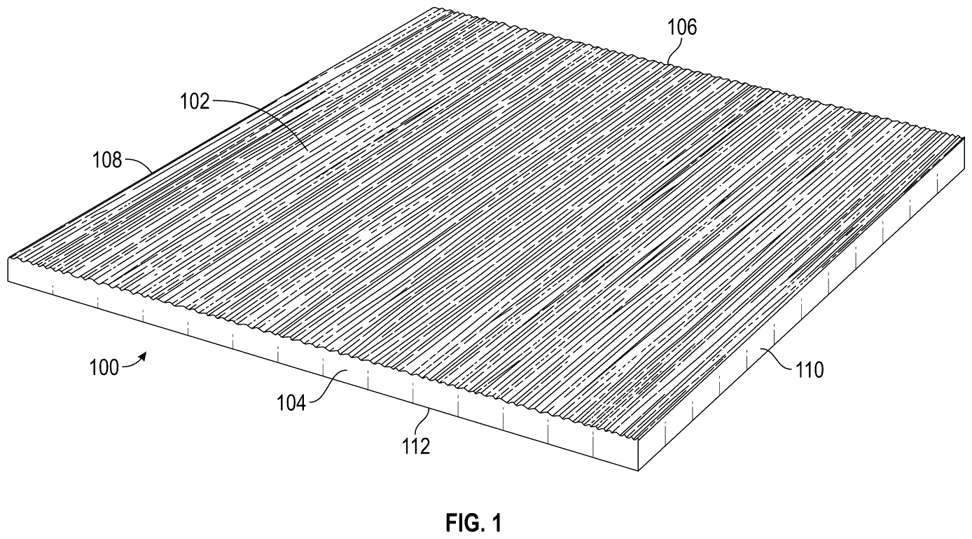

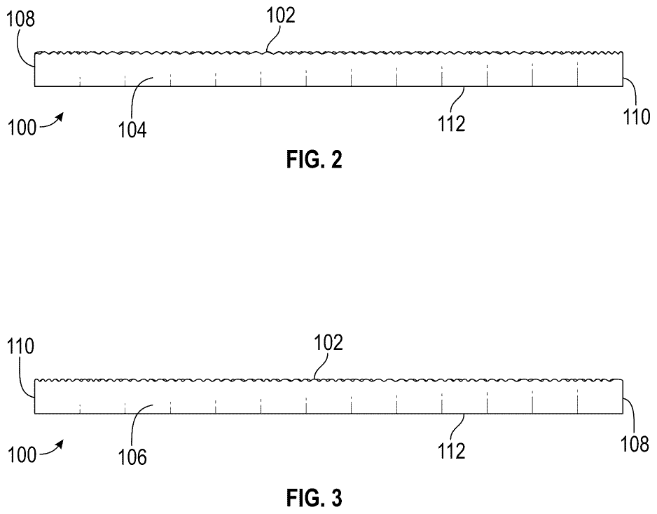

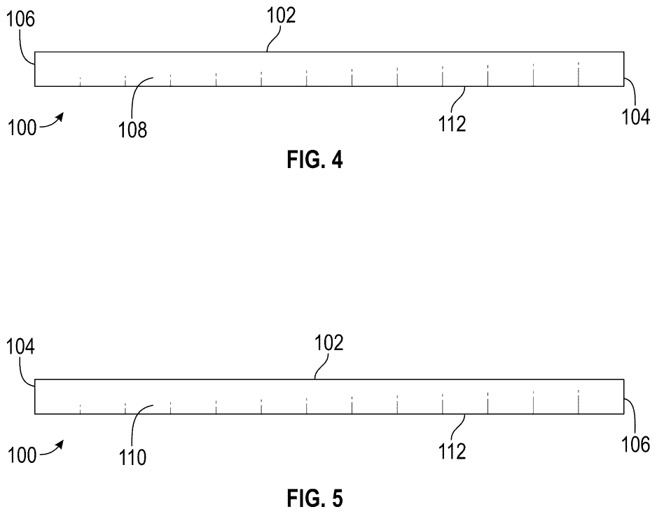

A first illustrative embodiment of a baking stone is seen generally at 100 in FIGS. 1-7. Initially, referring to the perspective view of FIG. 1, it can be seen that the baking stone 100 comprises a stone body portion, the stone body portion including a first surface (i.e., top surface 102) and a second surface (i.e., bottom surface 112), a third surface (i.e., front surface 104), a fourth surface (i.e., rear surface 106), a fifth surface (i.e., left side surface 108), and a sixth surface (i.e., right side surface 110). As shown in FIGS. 1-5, the second surface 112 is oppositely disposed relative to the first surface 102. In the first illustrative embodiment, the first surface 102 has a textured surface geometry for enhancing control of heat transfer during a baking process, the textured surface geometry including pluralities of protrusions and recesses, and the pluralities of protrusions and recesses configured to modify thermal dynamics between a baking surface and an item being baked. The baking stone 100 enables cooking at increased temperatures, while minimizing a risk of burning a bottom of the item being baked, thereby improving an overall baking experience.

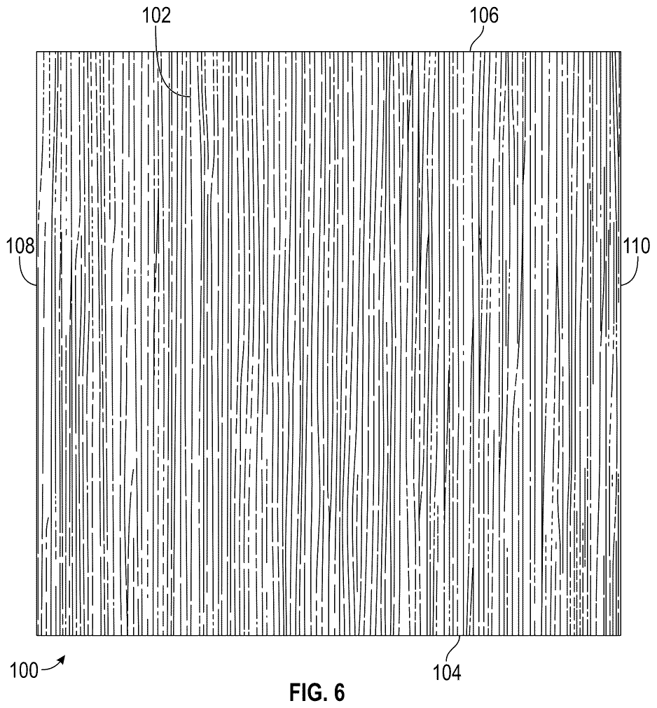

Referring again to FIGS. 1 and 6 of the first illustrative embodiment, it can be seen that the textured surface geometry of the first surface 102 of the stone body portion comprises a series of randomly arranged protrusions and recesses that form high and low ribs so as to allow the item being baked to rest on the protrusions while minimizing direct contact with the recesses so as to alter a surface contact area of the item being baked. The baking stone 100 is configured to effectively regulate a heat transfer rate, thereby ensuring that a top of the item being baked cooks at a desired oven temperature, while the bottom of the item being baked cooks at a slower rate as compared to conventional baking devices. The baking stone 100 employs randomly arranged raised ribs and recessed areas, which reduce direct contact between the food and the stone, enabling controlled heat flow.

In the illustrative embodiment, the textured surface geometry of the first surface 102 of the stone body portion is further configured to provide an inherent non-stick effect, thereby reducing a need for additional flours, oils, or non-stick coatings during the baking process. This characteristic of the baking stone 100 facilitates the easy removal of baked goods and simplifies post-baking cleanup. Additionally, the textured surface geometry camouflages wear, stains, and scratches over time. The baking stone is applicable to various stone sizes and configurations, ensuring adaptability to diverse baking applications.

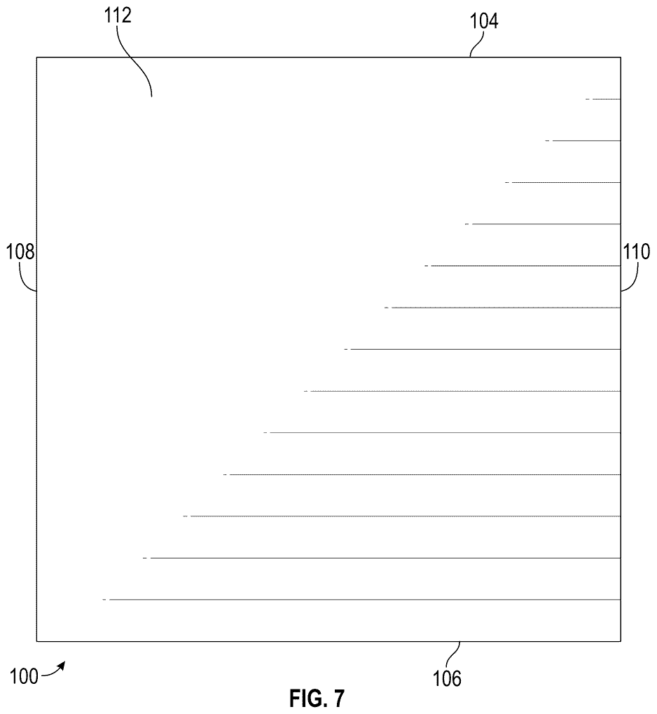

Next, with reference to FIGS. 1 and 7 of the first illustrative embodiment, it can be seen that the first surface 102 of the baking stone 100, which has the textured surface geometry, is configured for high heat or specialized baking, while the second surface 112 of the baking stone 100 has a smooth surface geometry for low-temperature or standard baking such that the baking stone 100 has a dual-surface design that provides flexibility in cooking methods to accommodate various baking needs.

In an alternative embodiment, rather than having a smooth surface geometry as depicted in the embodiment of FIGS. 1 and 7, the second surface of the baking stone may have an additional textured surface geometry configured for specialized baking such that the baking stone has a dual-surface design that provides flexibility in cooking methods to accommodate various baking needs.

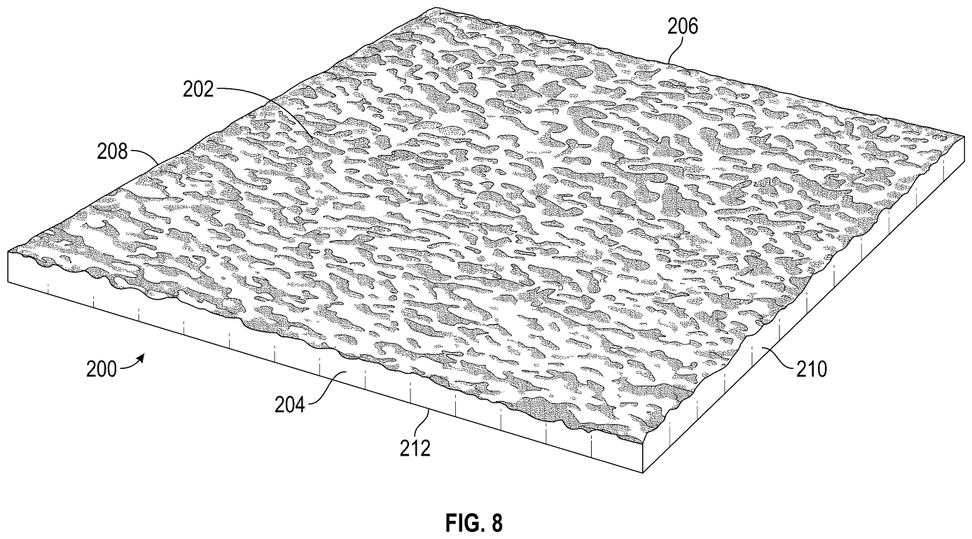

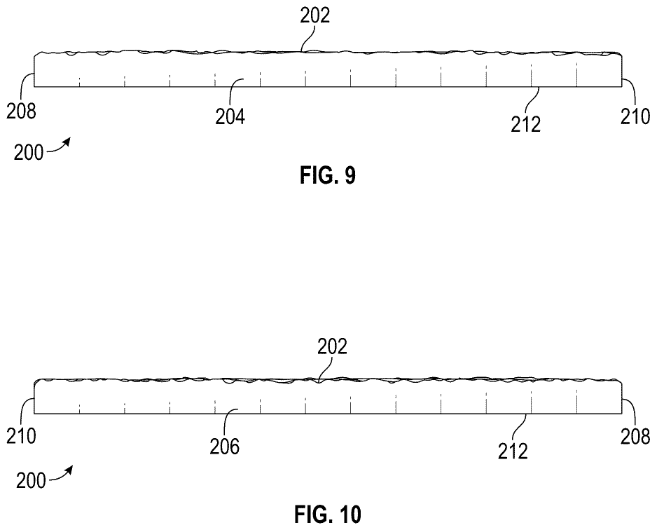

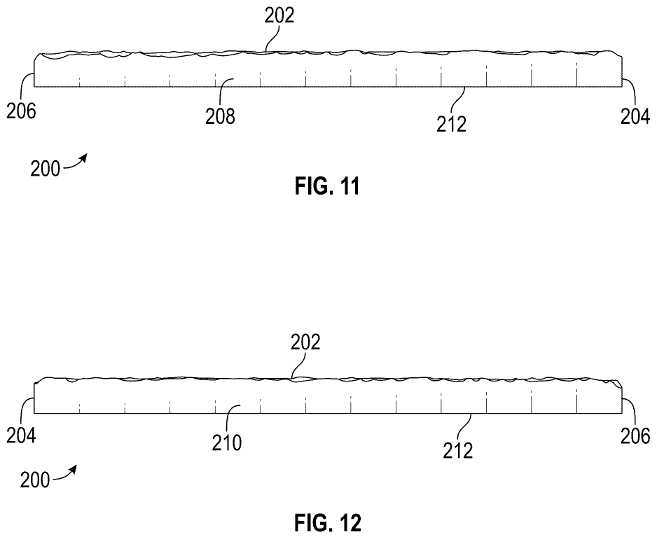

A second illustrative embodiment of a baking stone is seen generally at 200 in FIGS. 8-14. Initially, referring to the perspective view of FIG. 8, it can be seen that the baking stone 200 comprises a stone body portion, the stone body portion including a first surface (i.e., top surface 202) and a second surface (i.e., bottom surface 212), a third surface (i.e., front surface 204), a fourth surface (i.e., rear surface 206), a fifth surface (i.e., left side surface 208), and a sixth surface (i.e., right side surface 210). As shown in FIGS. 8-12, the second surface 212 is oppositely disposed relative to the first surface 202. In the second illustrative embodiment, the first surface 202 has a different textured surface geometry for enhancing control of heat transfer during a baking process, the textured surface geometry including pluralities of protrusions and recesses, and the pluralities of protrusions and recesses configured to modify thermal dynamics between a baking surface and an item being baked. The baking stone 200 enables cooking at increased temperatures, while minimizing a risk of burning a bottom of the item being baked, thereby improving an overall baking experience.

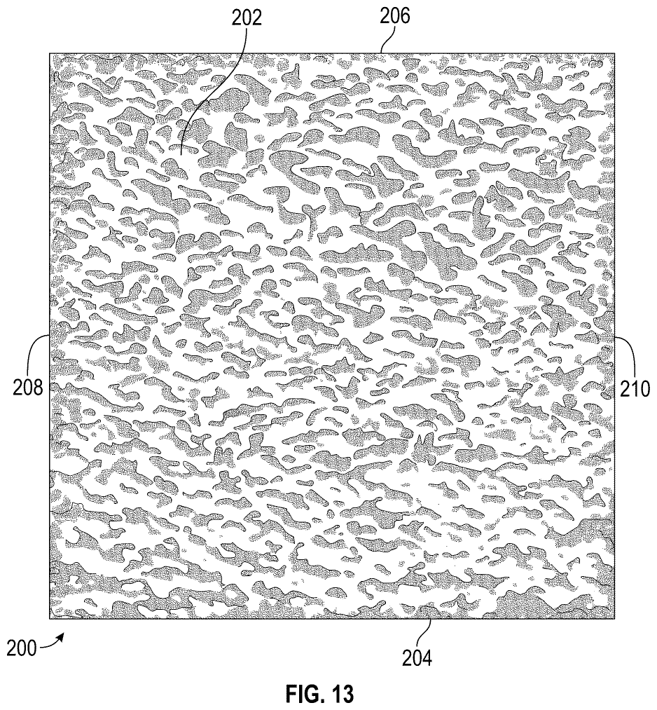

Referring again to FIGS. 8 and 13 of the second illustrative embodiment, it can be seen that the textured surface geometry of the first surface 202 of the stone body portion comprises crater-like depressions that form high and low regions so as to allow the item being baked to rest on the high regions while minimizing direct contact with the low regions so as to alter a surface contact area of the item being baked. The baking stone 200 is configured to effectively regulate a heat transfer rate, thereby ensuring that a top of the item being baked cooks at a desired oven temperature, while the bottom of the item being baked cooks at a slower rate as compared to conventional baking devices. Similar to the first illustrative embodiment, the design of the baking stone 200 creates elevated points where the baked item rests, thereby reducing contact with the baking surface. Again, by altering the surface contact area, the baking stone effectively regulates the heat transfer rate, contributing to an improved baking outcome. The baking stone 200 incorporates crater-like depressions, which similarly reduce surface contact but with an added focus on achieving delicate adjustments in heat transfer for varied baking styles.

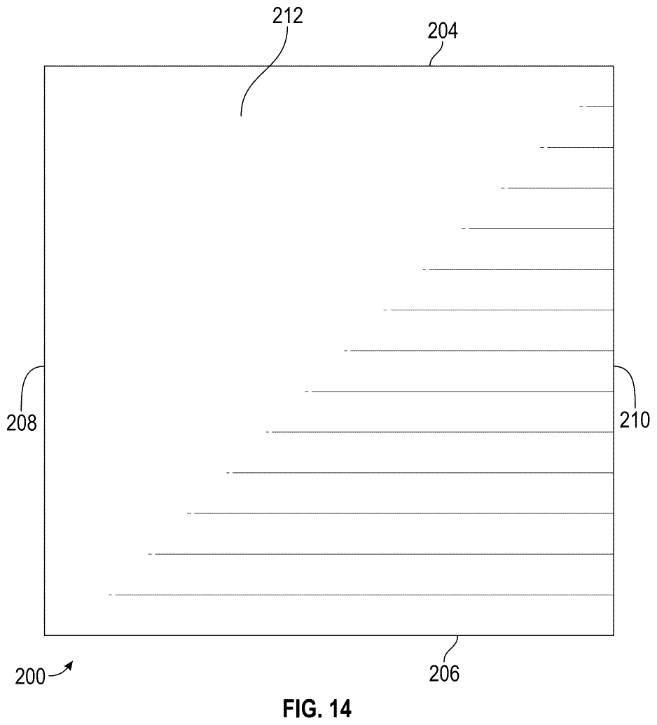

Next, with reference to FIGS. 8 and 14 of the second illustrative embodiment, it can be seen that the first surface 202 of the baking stone 200, which has the textured surface geometry, is configured for high heat or specialized baking, while the second surface 212 of the baking stone 200 has a smooth surface geometry for low-temperature or standard baking such that the baking stone 200 has a dual-surface design that provides flexibility in cooking methods to accommodate various baking needs.

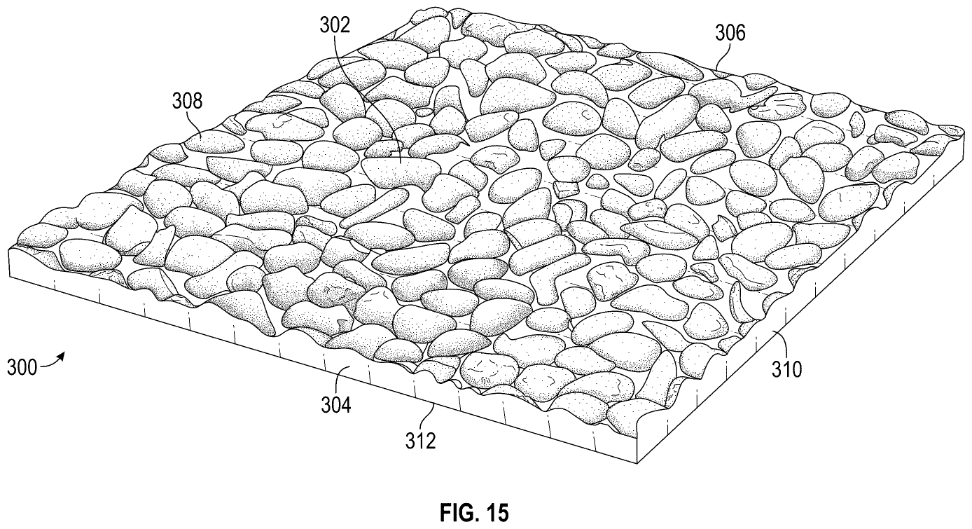

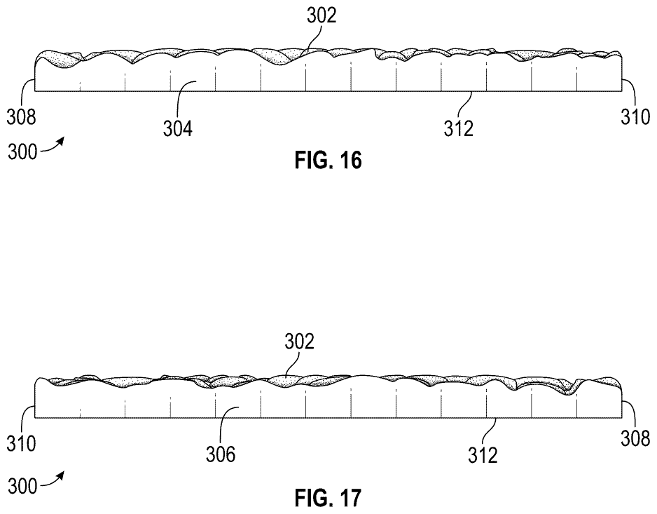

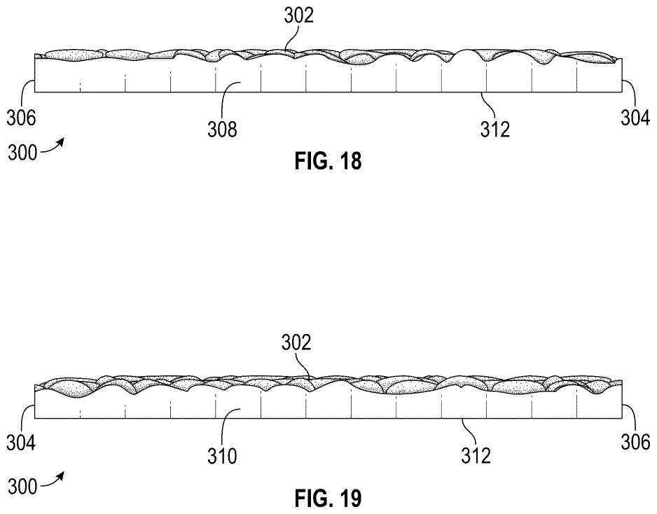

A third illustrative embodiment of a baking stone is seen generally at 300 in FIGS. 15-21. Initially, referring to the perspective view of FIG. 15, it can be seen that the baking stone 300 comprises a stone body portion, the stone body portion including a first surface (i.e., top surface 302) and a second surface (i.e., bottom surface 312), a third surface (i.e., front surface 304), a fourth surface (i.e., rear surface 306), a fifth surface (i.e., left side surface 308), and a sixth surface (i.e., right side surface 310). As shown in FIGS. 15-21, the second surface 312 is oppositely disposed relative to the first surface 302. In the third illustrative embodiment, the first surface 302 has a different textured surface geometry for enhancing control of heat transfer during a baking process, the textured surface geometry including pluralities of protrusions and recesses, and the pluralities of protrusions and recesses configured to modify thermal dynamics between a baking surface and an item being baked. The baking stone 300 enables cooking at increased temperatures, while minimizing a risk of burning a bottom of the item being baked, thereby improving an overall baking experience.

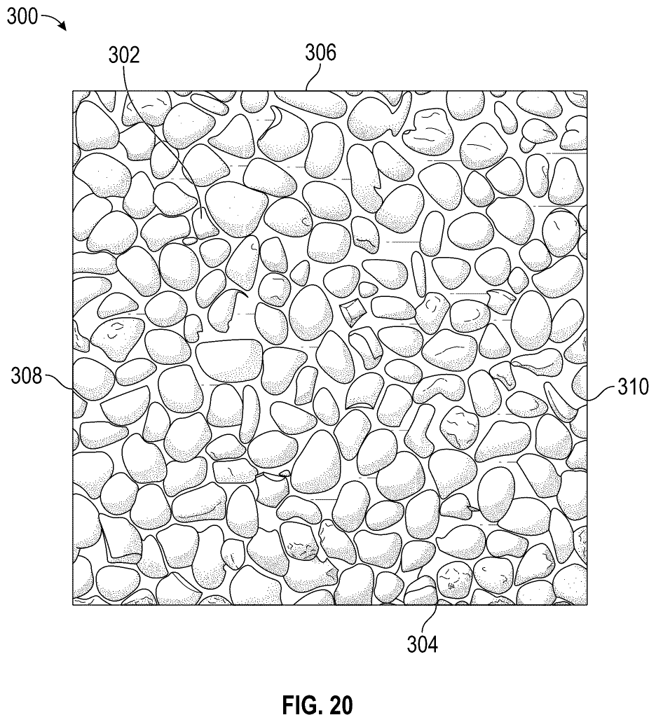

Referring again to FIGS. 15 and 20 of the third illustrative embodiment, it can be seen that the textured surface geometry of the first surface 302 of the stone body portion comprises a pebble-like texture that forms high and low regions so as to allow the item being baked to rest on the high regions while minimizing direct contact with the low regions so as to alter a surface contact area of the item being baked. The baking stone 300 is configured to effectively regulate a heat transfer rate, thereby ensuring that a top of the item being baked cooks at a desired oven temperature, while the bottom of the item being baked cooks at a slower rate as compared to conventional baking devices (e.g., conventional baking stones with flat top surfaces).

In the third illustrative embodiment, the pebble-like texture of the first surface 302 of the stone body portion is further configured to impart a distinctive shape to the item being baked by allowing the bottom of the item being baked to conform to the pebble-like texture, thereby resulting in a unique appearance and enhanced authenticity in a final baked product. The design of the baking stone 300 is particularly suited for traditional breads, such as Sangak, which are historically baked on small stones. The pebbled surface 302 of the baking stone 300 allows the dough to conform naturally to the texture, resulting in a unique appearance and enhanced authenticity in the final baked product. As such, the pebbled surface 302 of the baking stone 300 replicates traditional baking techniques used for products like Sangak bread, enhancing both the aesthetic and functional qualities of the baked goods.

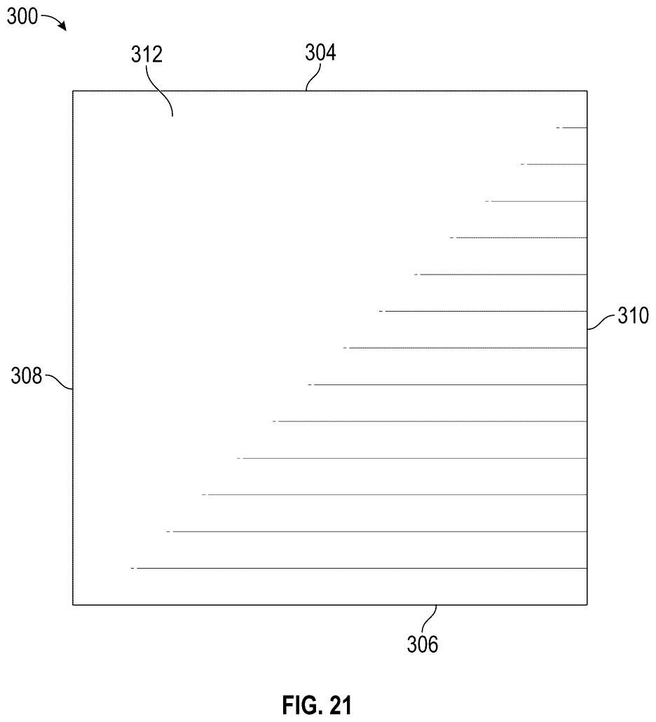

Next, with reference to FIGS. 15 and 21 of the third illustrative embodiment, it can be seen that the first surface 302 of the baking stone 300, which has the textured surface geometry, is configured for high heat or specialized baking, while the second surface 312 of the baking stone 300 has a smooth surface geometry for low-temperature or standard baking such that the baking stone 300 has a dual-surface design that provides flexibility in cooking methods to accommodate various baking needs. Advantageously, in the illustrative embodiments described herein, the baking stone enables the modulation of heat transfer rates. By utilizing innovative surface textures alongside the dual-surface design, the baking stone allows for greater versatility in baking techniques, particularly in modern ovens that operate at elevated temperatures. The baking stone described herein innovatively alters the contact surface area to impact the thermal interaction between the stone and the baked items, thereby enhancing cooking efficiency and effectiveness. The baking stone described herein enables controlled variation in heat transfer across the baking surface. Altering the contact surface area also facilitates differential heat diffusion, allowing for the top of baked goods to reach higher temperatures while the bottom experiences moderated heat exposure, resulting in a refined baking process.

In the illustrative embodiments described herein, the baking stone may be used for baking various food items. For example, the baking stone may be used as a pizza stone for baking pizzas in an oven. In any of these particular baking applications, the baking stone may provide thermal modulation and/or controlled heat transfer to the food item being baked. Also, in the illustrative embodiments described herein, the baking stone may be formed from various suitable materials, such as: (i) clay, (ii) ceramic, (iii) stone, (iv) cordierite, (v) soapstone, (vi) granite, or (vii) a specialized ceramic formulation (e.g., Fibrament®).

In the illustrative embodiments described herein, the textured surface(s) of the baking stone incorporates various patterns of protrusions and recesses, which serve to modify the thermal dynamics between the baking surface and the item being baked. Advantageously, the baking stone enables cooking at higher temperatures without the risk of burning the bottoms of baked goods, thereby improving the overall baking experience through enhanced baking stone performance. Advantageously, the distinctive surface features of the baking stone described herein enables users to achieve optimal results while exploring a wider range of baking styles and recipes.

In the illustrative embodiments described herein, the baking stone not only addresses issues related to non-stick properties and heat distribution, but also provides a novel approach to managing heat transfer in modern high-temperature ovens. By utilizing these advanced surface textures, the baking stone offers enhanced baking versatility across a wide range of cooking techniques, while improving the longevity and usability of the baking stone.

In the illustrative embodiments described herein, the baking stone has one or more of the following properties: (i) thermal control and modulation; (ii) differential heat transfer, rather than uniform surface effects; and (iii) baked product surface texturing (e.g., for specific types of bread).

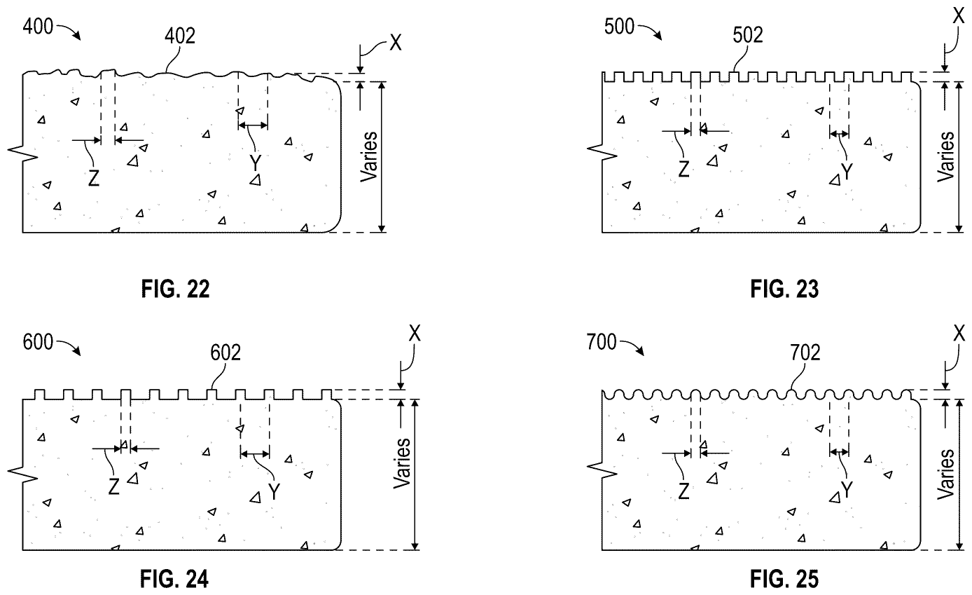

Now, turning to FIGS. 22-28, embodiments of various baking stones having different textured surface geometries will be described. In these embodiments, as shown in FIGS. 22-28, the height of the baking stone may vary (e.g., from ¼″ to 3″). Initially, referring to FIG. 22, it can be seen that a baking stone 400 has a first surface (i.e., top surface 402) with a textured surface geometry similar to that of the first illustrative embodiment described above. More specifically, as shown in FIG. 22, the first surface 402 of the baking stone 400 has a random linear surface texture. Alternatively, a similar uniform linear surface texture could be provided on the baking stone 400. In the embodiment of FIG. 22, the “X” dimension may have a value between approximately 1/32″ and approximately ¼″, inclusive of the endpoints (or between 1/32″ and ¼″, inclusive of the endpoints). In the embodiment of FIG. 22, the “Y” dimension may have a value between approximately ⅛″ and approximately ½″, inclusive of the endpoints (or between ⅛″ and ½″, inclusive of the endpoints). In the embodiment of FIG. 22, the “Z” dimension may have a value between approximately 1/32″ and approximately 5/16″, inclusive of the endpoints (or between 1/32″ and 5/16″, inclusive of the endpoints).

Turning to FIG. 23, it can be seen that a baking stone 500 has a first surface (i.e., top surface 502) with a first alternative textured surface geometry. More specifically, as shown in FIG. 23, the first surface 502 of the baking stone 500 has a uniform linear or non-linear surface texture. Alternatively, a similar random linear surface texture could be provided on the baking stone 500. In the embodiment of FIG. 23, the “X” dimension may have a value between approximately 1/32″ and approximately ⅜″, inclusive of the endpoints (or between 1/32″ and ⅜″, inclusive of the endpoints). In the embodiment of FIG. 23, the “Y” dimension may have a value between approximately 1/16″ and approximately ¾″, inclusive of the endpoints (or between 1/16″ and ¾″, inclusive of the endpoints). In the embodiment of FIG. 23, the “Z” dimension may have a value between approximately 1/32″ and approximately ⅜″, inclusive of the endpoints (or between 1/32″ and ⅜″, inclusive of the endpoints).

Referring to FIG. 24, it can be seen that a baking stone 600 has a first surface (i.e., top surface 602) with a second alternative textured surface geometry. More specifically, as shown in FIG. 24, the first surface 602 of the baking stone 600 has a uniform linear surface texture. Alternatively, a similar random linear surface texture could be provided on the baking stone 600. In the embodiment of FIG. 24, the “X” dimension may have a value between approximately 1/32″ and approximately ⅜″, inclusive of the endpoints (or between 1/32″ and ⅜″, inclusive of the endpoints). In the embodiment of FIG. 24, the “Y” dimension may have a value between approximately 1/16″ and approximately ¾″, inclusive of the endpoints (or between 1/16″ and ¾″, inclusive of the endpoints). In the embodiment of FIG. 24, the “Z” dimension may have a value between approximately 1/32″ and approximately ⅜″, inclusive of the endpoints (or between 1/32″ and ⅜″, inclusive of the endpoints).

Turning to FIG. 25, it can be seen that a baking stone 700 has a first surface (i.e., top surface 702) with a third alternative textured surface geometry. More specifically, as shown in FIG. 25, the first surface 702 of the baking stone 700 has a uniform linear or non-linear surface texture. Alternatively, a similar random linear surface texture could be provided on the baking stone 700. In the embodiment of FIG. 25, the “X” dimension may have a value between approximately 1/32″ and approximately ⅜″, inclusive of the endpoints (or between 1/32″ and ⅜″, inclusive of the endpoints). In the embodiment of FIG. 25, the “Y” dimension may have a value between approximately 1/16″ and approximately ¾″, inclusive of the endpoints (or between 1/16″ and ¾″, inclusive of the endpoints). In the embodiment of FIG. 25, the “Z” dimension may have a value between approximately 1/32″ and approximately ⅜″, inclusive of the endpoints (or between 1/32″ and ⅜″, inclusive of the endpoints).

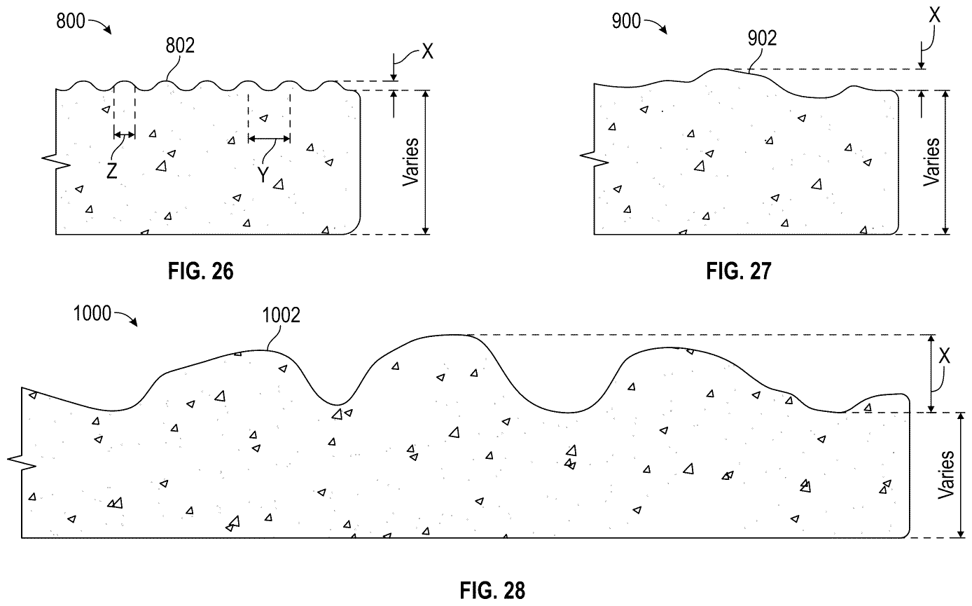

Referring to FIG. 26, it can be seen that a baking stone 800 has a first surface (i.e., top surface 802) with a fourth alternative textured surface geometry. More specifically, as shown in FIG. 26, the first surface 802 of the baking stone 800 has a uniform linear surface texture. Alternatively, a similar random linear surface texture could be provided on the baking stone 800. In the embodiment of FIG. 26, the “X” dimension may have a value between approximately 1/32″ and approximately ⅜″, inclusive of the endpoints (or between 1/32″ and ⅜″, inclusive of the endpoints). In the embodiment of FIG. 26, the “Y” dimension may have a value between approximately 1/16″ and approximately ¾″, inclusive of the endpoints (or between 1/16″ and ¾″, inclusive of the endpoints). In the embodiment of FIG. 26, the “Z” dimension may have a value between approximately 1/32″ and approximately ⅜″, inclusive of the endpoints (or between 1/32″ and ⅜″, inclusive of the endpoints).

Turning to FIG. 27, it can be seen that a baking stone 900 has a first surface (i.e., top surface 902) with a fifth alternative textured surface geometry. More specifically, as shown in FIG. 27, the first surface 902 of the baking stone 900 has a random moon-like surface texture. In the embodiment of FIG. 27, the “X” dimension may have a value between approximately ⅛″ and approximately ¾″, inclusive of the endpoints (or between ⅛″ and ¾″, inclusive of the endpoints).

Referring to FIG. 28, it can be seen that a baking stone 1000 has a first surface (i.e., top surface 1002) with a sixth alternative textured surface geometry. More specifically, as shown in FIG. 28, the first surface 1002 of the baking stone 1000 has a random stone/pebble surface texture. Alternatively, a similar uniform stone/pebble surface texture could be provided on the baking stone 1000. In the embodiment of FIG. 28, the “X” dimension may have a value between approximately ⅛″ and approximately 1″, inclusive of the endpoints (or between ⅛″ and 1″, inclusive of the endpoints).

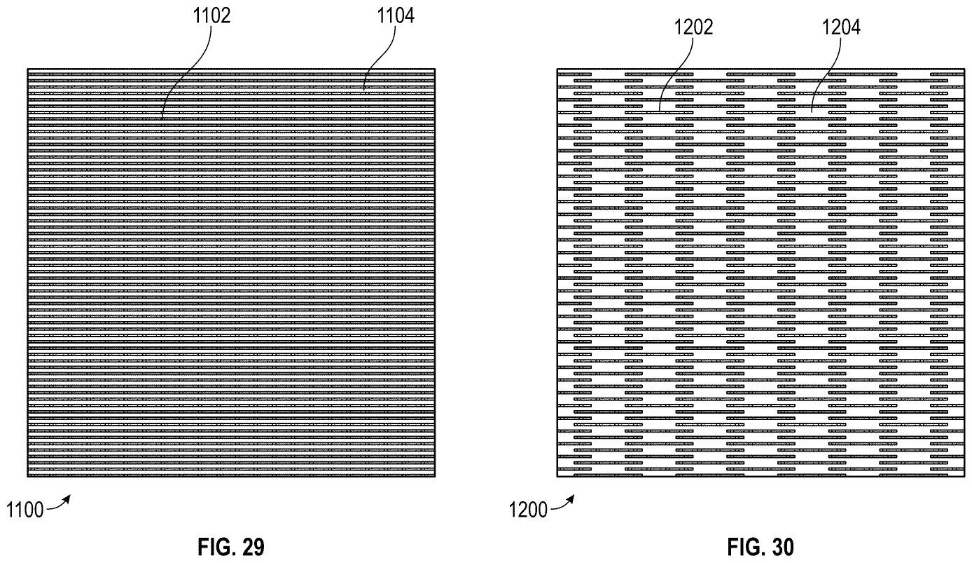

Next, turning to FIGS. 29-38, additional embodiments of surface patterns for baking stones designed in accordance with the principles of the present disclosure will be described. These exemplary surface patterns depicted in FIGS. 29-38 are alternatives to the surface patterns depicted in the first three illustrative embodiments above. Baking stones having the surface patterns depicted in FIGS. 29-38 also are capable of achieving the heat transfer functionality that was described above for the first three illustrative embodiments.

Initially, referring to FIG. 29, it can be seen that a baking stone 1100 has a heat transfer surface (e.g., top surface) with a linear surface pattern comprising a plurality of ribs 1102 separated by a plurality of gaps 1104 therebetween. The pattern of FIG. 29 can have ribs 1102 that are the same thickness as the gaps 1104. Alternatively, the gaps 1104 can be larger than the ribs 1102, or the ribs 1102 can be larger than the gaps 1104. The ribs 1102 can be continuous or dashed in any regular or random pattern. Rib width, height, and spacing can be as shown in the alternate embodiments of FIGS. 22, 23, 24, 25, or 26.

Turning to FIG. 30, it can be seen that a baking stone 1200 has a heat transfer surface (e.g., top surface) with a dashed surface pattern comprising a plurality of ribs 1202 separated by a plurality of gaps 1204 therebetween. The pattern of FIG. 30 can have ribs 1202 that are the same thickness as the gaps 1204. Alternatively, the gaps 1204 can be larger than the ribs 1202, or the ribs 1202 can be larger than the gaps 1204. The ribs 1202 can be continuous or dashed in any regular or random pattern. Rib width, height, and spacing can be as shown in the alternate embodiments of FIGS. 23, 24, 25, or 26.

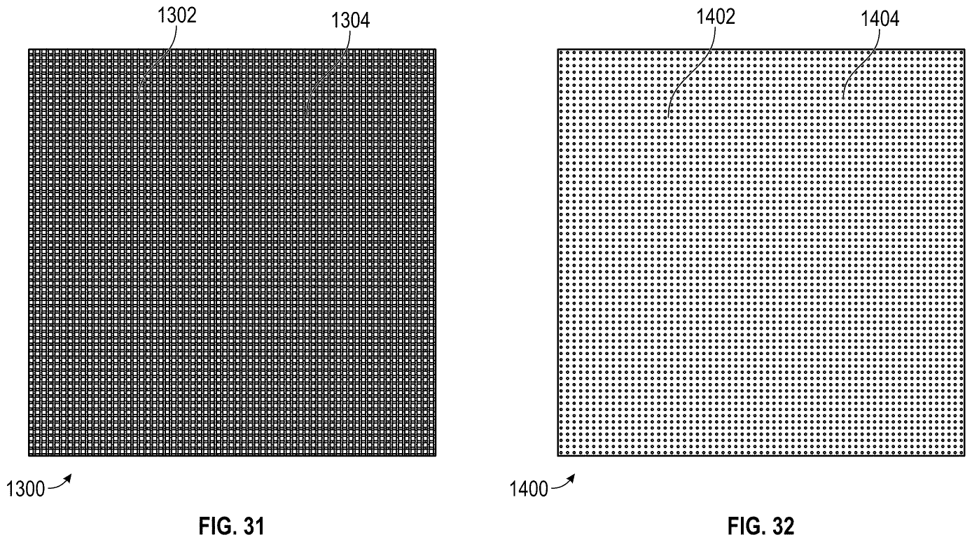

Referring to FIG. 31, it can be seen that a baking stone 1300 has a heat transfer surface (e.g., top surface) with a grid surface pattern comprising a plurality of ribs 1302 separated by a plurality of gaps 1304 therebetween. The pattern of FIG. 31 can have ribs 1302 that are the same thickness as the gaps 1304. Alternatively, the gaps 1304 can be larger than the ribs 1302, or the ribs 1302 can be larger than the gaps 1304 in order to make the grid of FIG. 31. The ribs 1302 can be continuous or dashed in any regular or random pattern. Rib width, height, and spacing can be as shown in the alternate embodiments of FIGS. 23, 24, 25, or 26.

Turning to FIG. 32, it can be seen that a baking stone 1400 has a heat transfer surface (e.g., top surface) with a dot surface pattern comprising a plurality of dots 1404 separated by a plurality of gaps 1402 therebetween. The pattern of FIG. 32 can have dots 1404 that are the same thickness as the gaps 1402. Alternatively, the gaps 1402 can be larger than the dots 1404, or the dots 1404 can be larger than the gaps 1402 in order to make the grid of FIG. 32. The dots 1404 can be in any regular or random pattern. Dot width, height, and spacing can be as shown in the alternate embodiments of FIGS. 23, 24, 25, or 26.

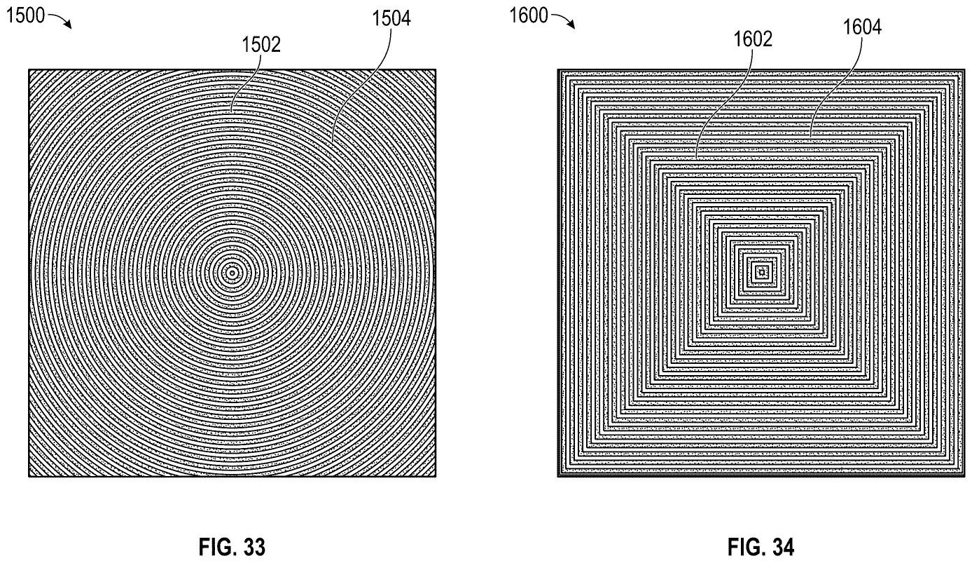

Referring to FIG. 33, it can be seen that a baking stone 1500 has a heat transfer surface (e.g., top surface) with a concentric circle surface pattern comprising a plurality of ribs 1502 separated by a plurality of gaps 1504 therebetween. The pattern of FIG. 33 can have ribs 1502 that are the same thickness as the gaps 1504. Alternatively, the gaps 1504 can be larger than the ribs 1502, or the ribs 1502 can be larger than the gaps 1504. The ribs 1502 can be continuous or dashed in any regular or random pattern. Rib width, height, and spacing can be as shown in the alternate embodiments of FIGS. 23, 24, 25, or 26.

Turning to FIG. 34, it can be seen that a baking stone 1600 has a heat transfer surface (e.g., top surface) with a concentric square surface pattern comprising a plurality of ribs 1602 separated by a plurality of gaps 1604 therebetween. The pattern of FIG. 34 can have ribs 1602 that are the same thickness as the gaps 1604. Alternatively, the gaps 1604 can be larger than the ribs 1602, or the ribs 1602 can be larger than the gaps 1604. The ribs 1602 can be continuous or dashed in any regular or random pattern. Rib width, height, and spacing can be as shown in the alternate embodiments of FIGS. 23, 24, 25, or 26.

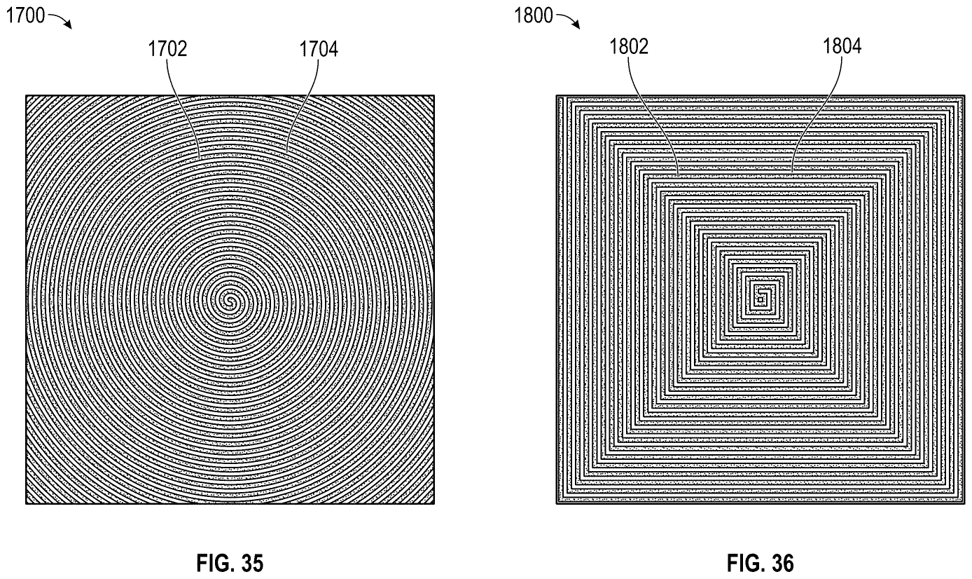

Referring to FIG. 35, it can be seen that a baking stone 1700 has a heat transfer surface (e.g., top surface) with a spiral circle surface pattern comprising a plurality of ribs 1702 separated by a plurality of gaps 1704 therebetween. The pattern of FIG. 35 can have ribs 1702 that are the same thickness as the gaps 1704. Alternatively, the gaps 1704 can be larger than the ribs 1702, or the ribs 1702 can be larger than the gaps 1704. The ribs 1702 can be continuous or dashed in any regular or random pattern. Rib width, height, and spacing can be as shown in the alternate embodiments of FIGS. 23, 24, 25, or 26.

Turning to FIG. 36, it can be seen that a baking stone 1800 has a heat transfer surface (e.g., top surface) with a spiral square surface pattern comprising a plurality of ribs 1802 separated by a plurality of gaps 1804 therebetween. The pattern of FIG. 36 can have ribs 1802 that are the same thickness as the gaps 1804. Alternatively, the gaps 1804 can be larger than the ribs 1802, or the ribs 1802 can be larger than the gaps 1804. The ribs 1802 can be continuous or dashed in any regular or random pattern. Rib width, height, and spacing can be as shown in the alternate embodiments of FIGS. 23, 24, 25, or 26.

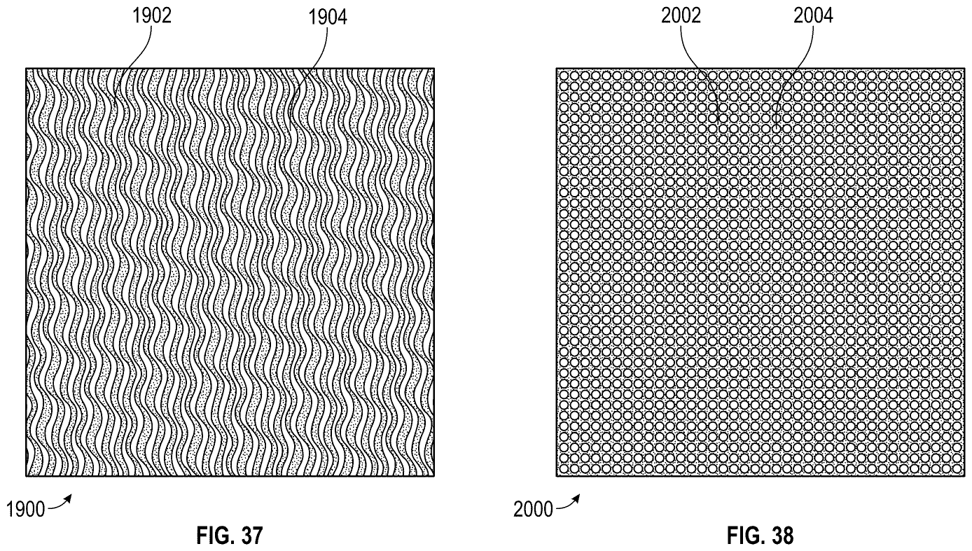

Referring to FIG. 37, it can be seen that a baking stone 1900 has a heat transfer surface (e.g., top surface) with a wood grain surface pattern comprising a plurality of ribs 1902 separated by a plurality of gaps 1904 therebetween. The pattern of FIG. 37 can have ribs 1902 that are the same thickness as the gaps 1904. Alternatively, the gaps 1904 can be larger than the ribs 1902, or the ribs 1902 can be larger than the gaps 1904. The ribs 1902 can be continuous or dashed in any regular or random pattern. Rib width, height, and spacing can be as shown in the alternate embodiments of FIGS. 23, 24, 25, or 26.

Turning to FIG. 38, it can be seen that a baking stone 2000 has a heat transfer surface (e.g., top surface) with a perforated surface pattern comprising a plurality of holes 2004 separated by a plurality of frame elements 2002 therebetween. The pattern of FIG. 38 can have holes 2004 that are larger or smaller, uniform or irregular shapes. The frame elements 2002 around the holes 2004 can also be larger or smaller, uniform or irregular shapes. The hole pattern spacing can be uniform or random. Frame/hole width, height, and spacing can be as shown in the alternate embodiments of FIGS. 23, 24, 25, or 26.

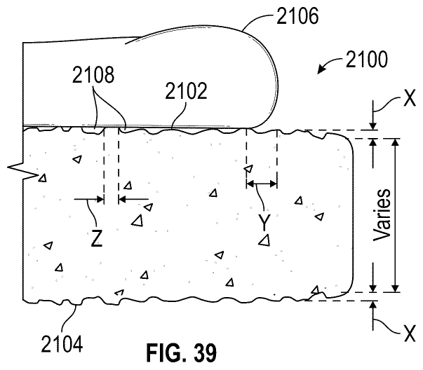

Referring to FIG. 39, it can be seen that a baking stone 2100 has a first surface (i.e., top surface 2102) with a first textured surface geometry and a second surface (i.e., bottom surface 2104) with a second textured surface geometry. In the embodiment of FIG. 39, the first and second textured surface geometries comprise similar random linear surface textures. In an alternative embodiment, similar uniform linear surface textures could be provided on the first and second surfaces 2102, 2104 of the baking stone 2100. In yet an alternative embodiment, different surface texture patterns could be provided on the first and second surfaces 2102, 2104 of the baking stone 2100. In the embodiment of FIG. 39, the “X” dimension may have a value between approximately 1/32″ and approximately ¼″, inclusive of the endpoints (or between 1/32″ and ¼″, inclusive of the endpoints). In the embodiment of FIG. 39, the “Y” dimension may have a value between approximately ⅛″ and approximately ½″, inclusive of the endpoints (or between ⅛″ and ½″, inclusive of the endpoints). In the embodiment of FIG. 39, the “Z” dimension may have a value between approximately 1/32″ and approximately 5/16″, inclusive of the endpoints (or between 1/32″ and 5/16″, inclusive of the endpoints).

With reference again to FIG. 39, it can be seen that the random linear surface textures of the baking stone 2100 comprise a series of randomly arranged protrusions and recesses that form high and low ribs so as to allow the item being baked (e.g., bread 2106) to rest on the protrusions while minimizing direct contact with the recesses so as to alter a surface contact area of the item 2106 being baked. As such, the baking stone 2100 is configured to effectively regulate a heat transfer rate, thereby ensuring that a top of the item 2106 being baked cooks at a desired oven temperature, while the bottom of the item 2106 being baked cooks at a slower rate as compared to conventional baking devices (e.g., conventional baking stones with flat top surfaces). In FIG. 39, it can be seen that the recesses are configured to create air gaps 2108 between a bottom surface of the item 2106 being baked and the first surface 2102 of the stone body portion so that the bottom surface of the item 2106 being baked is spaced apart from the bottom floors of the recesses. In the locations where the bottom surface of the item 2106 contacts the protrusions of the baking stone 2100, heat transfer from the baking stone 2100 to the item 2106 occurs primarily by means of conduction as the heat energy stored in the baking stone 2100 is released. In contrast, in the locations where the bottom surface of the item 2106 is spaced apart from the baking stone 2100 by the air gaps 2108, heat transfer from the baking stone 2100 to the item 2106 occurs by means of convection and conduction through the air. As such, in the locations where the bottom surface of the item 2106 is spaced apart from the baking stone 2100 by the air gaps 2108, the rate of heat transfer is less than in the locations where the bottom surface of the item 2106 contacts the protrusions of the baking stone 2100.

It is readily apparent that the aforedescribed baking stone offers numerous advantages. As described above, the textured baking stone is designed to optimize heat transfer and cooking outcomes by utilizing novel surface geometries. The stone features intricately designed surface textures, including protrusions, recesses, and crater-like depressions, which allow precise modulation of thermal conductivity during the baking process. This design enables high-temperature baking with minimized risk of burning or overcooking the bottom of food products, while promoting balanced heat distribution for superior cooking results.

Recitation of ranges of values herein are merely intended to serve as a shorthand method of referring individually to each separate value falling within the range, unless otherwise indicated herein, and each separate value is incorporated into the specification as if it were individually recited herein. For example, if a dimensional range is stated as between ⅛″ and ½″, it is intended that values such as between 3/16″ and ¼″, between ¼″ and ½″, or between ⅛″ and 3/16″, etc., are expressly enumerated in this specification. These are only examples of what is specifically intended, and all possible combinations of numerical values between and including the lowest value and the highest value enumerated are to be considered to be expressly stated in this disclosure. “Approximately” is used to provide flexibility to a numerical range endpoint by providing that a given value may be “slightly above” or “slightly below” the endpoint without affecting the desired result.

Any of the features or attributes of the above described embodiments and variations can be used in combination with any of the other features and attributes of the above described embodiments and variations as desired.

Although the invention has been shown and described with respect to a certain embodiment or embodiments, it is apparent that this invention can be embodied in many different forms and that many other modifications and variations are possible without departing from the spirit and scope of this invention.

While exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. A baking stone, comprising:
a stone body portion, the stone body portion including a first surface and a second surface, the second surface being oppositely disposed relative to the first surface, and the first surface having a textured surface geometry for enhancing control of heat transfer during a baking process, the textured surface geometry including pluralities of protrusions and recesses, the pluralities of protrusions and recesses configured to modify thermal dynamics between a baking surface and an item being baked;
wherein the baking stone enables cooking at increased temperatures, while minimizing a risk of burning a bottom of the item being baked, thereby improving an overall baking experience.

2. The baking stone according to claim 1, wherein the first surface having the textured surface geometry is configured for high heat or specialized baking; and
wherein the second surface has a smooth surface geometry for low-temperature or standard baking such that the baking stone has a dual-surface design that provides flexibility in cooking methods to accommodate various baking needs.

3. The baking stone according to claim 1, wherein the textured surface geometry of the first surface of the stone body portion comprises a series of randomly arranged protrusions and recesses that form high and low ribs so as to allow the item being baked to rest on the protrusions while minimizing direct contact with the recesses so as to alter a surface contact area of the item being baked, the baking stone configured to effectively regulate a heat transfer rate, thereby ensuring that a top of the item being baked cooks at a desired oven temperature, while the bottom of the item being baked cooks at a slower rate as compared to conventional baking devices.

4. The baking stone according to claim 3, wherein at least one of the recesses is configured to create a gap between the bottom of the item being baked and the first surface of the stone body portion so as to regulate the heat transfer rate of the baking stone.

5. The baking stone according to claim 1, wherein the textured surface geometry of the first surface of the stone body portion comprises crater-like depressions that form high and low regions so as to allow the item being baked to rest on the high regions while minimizing direct contact with the low regions so as to alter a surface contact area of the item being baked, the baking stone configured to effectively regulate a heat transfer rate, thereby ensuring that a top of the item being baked cooks at a desired oven temperature, while the bottom of the item being baked cooks at a slower rate as compared to conventional baking devices.

6. The baking stone according to claim 1, wherein the textured surface geometry of the first surface of the stone body portion comprises a pebble-like texture that forms high and low regions so as to allow the item being baked to rest on the high regions while minimizing direct contact with the low regions so as to alter a surface contact area of the item being baked, the baking stone configured to effectively regulate a heat transfer rate, thereby ensuring that a top of the item being baked cooks at a desired oven temperature, while the bottom of the item being baked cooks at a slower rate as compared to conventional baking devices.

7. The baking stone according to claim 6, wherein the pebble-like texture of the first surface of the stone body portion is further configured to impart a distinctive shape to the item being baked by allowing the bottom of the item being baked to conform to the pebble-like texture, thereby resulting in a unique appearance and enhanced authenticity in a final baked product.

8. The baking stone according to claim 1, wherein the textured surface geometry of the first surface of the stone body portion is further configured to provide a non-stick effect, thereby reducing a need for additional flours or oils during the baking process.

9. The baking stone according to claim 1, wherein the second surface has an additional textured surface geometry configured for specialized baking such that the baking stone has a dual-surface design that provides flexibility in cooking methods to accommodate various baking needs.

10. A baking stone, comprising:
a stone body portion, the stone body portion including a first surface and a second surface, the second surface being oppositely disposed relative to the first surface, the first surface having a first textured surface geometry for enhancing control of heat transfer during a baking process, the second surface having a second textured surface geometry configured for specialized baking such that the baking stone has a dual-surface design that provides flexibility in cooking methods to accommodate various baking needs, at least one of the first textured surface geometry and the second textured surface geometry including pluralities of protrusions and recesses, the pluralities of protrusions and recesses configured to modify thermal dynamics between a baking surface and an item being baked;
wherein the baking stone enables cooking at increased temperatures, while minimizing a risk of burning a bottom of the item being baked, thereby improving an overall baking experience.

11. The baking stone according to claim 10, wherein the at least one of the first textured surface geometry and the second textured surface geometry of the stone body portion comprises a series of randomly arranged protrusions and recesses that form high and low ribs so as to allow the item being baked to rest on the protrusions while minimizing direct contact with the recesses so as to alter a surface contact area of the item being baked, the baking stone configured to effectively regulate a heat transfer rate, thereby ensuring that a top of the item being baked cooks at a desired oven temperature, while the bottom of the item being baked cooks at a slower rate as compared to conventional baking devices.

12. The baking stone according to claim 11, wherein at least one of the recesses is configured to create a gap between the bottom of the item being baked and the first surface or the second surface of the stone body portion so as to regulate the heat transfer rate of the baking stone.

13. The baking stone according to claim 10, wherein at least one of the first textured surface geometry and the second textured surface geometry of the stone body portion is further configured to provide a non-stick effect, thereby reducing a need for additional flours or oils during the baking process.
